(19) United States
(12) Patent Application Publication
(10) Pub. No.: US 2025/0362444 A1
(43) Pub. Date: Nov. 27, 2025

(54) SOLAR SIGN

(71) Applicant: OPTOGLO, INC., LEOMINSTER, MA (US)

(72) Inventors: Kevin Donahue, Harvard, MA (US); Douglas Kirkpatrick, Leominster, MA (US)

(21) Appl. No.: 19/296,373

(22) Filed: Aug. 11, 2025

Related U.S. Application Data
(63) Continuation-in-part of application No. 18/673,793, filed on May 24, 2024.
Application No. 18/673,793 is a continuation-in-part of application No. 18/405,419, filed on Jan. 5, 2024, now abandoned.
Application No. 18/405,419 is a continuation of application No. 17/696,761, filed on Mar. 16, 2022, now Pat. No. 11,880,060.
Application No. 18/673,793 is a continuation-in-part of application No. 17/718,212, filed on Apr. 11, 2022, now abandoned.
(63) Continuation-in-part of application No. PCT/US2024/028014, filed on May 6, 2024.
(63) Continuation-in-part of application No. PCT/US2024/032291, filed on Jun. 3, 2024.
(60) Provisional application No. 63/162,329, filed on Mar. 17, 2021.
(60) Provisional application No. 63/173,801, filed on Apr. 12, 2021.
(60) Provisional application No. 63/500,212, filed on May 4, 2023.
(60) Provisional application No. 63/505,559, filed on Jun. 1, 2023.

(51) Int. Cl. F21V 8/00; F21S 2/00; F21S 9/03; F21Y 115/10

(52) U.S. Cl. CPC G02B 6/006; F21S 2/005; F21S 9/03; G02B 6/0051; F21Y 2115/10

(57) ABSTRACT

The systems and methods of the present disclosure provide solar-powered signs that can direct power to and/or control light sources for illuminating content. In some implementations, a frame of a solar-powered sign supports a solar sign sheet. A solar panel is disposed relative to the frame. A light source is configured to illuminate the solar sign sheet. A battery is configured to store power generated via the solar panel and provide power to control circuitry configured to control the light source.

### CROSS-REFERENCE TO RELATED APPLICATIONS

The present patent application is a continuation-in-part of and claims priority to and the benefit of Patent Cooperation Treaty Application No. PCT/US2024/028014, titled “DUAL-SIDED SOLAR POWERED SIGN” and filed May 6, 2024, which claims priority to and the benefit of U.S. Provisional Application No. 63/500,212, titled “DUAL-SIDED SOLAR POWERED SIGN” and filed May 4, 2023.

The present patent application is also a continuation-in-part of and claims priority to and the benefit of Patent Cooperation Treaty Application No. PCT/US2024/032291, titled “SOLAR-POWERED SIGNS WITH DYNAMIC DIGITAL OVERLAYS” and filed Jun. 3, 2024, which claims priority to and the benefit of U.S. Provisional Patent Application No. 63/505,559, titled “SOLAR-POWERED SIGNS WITH DYNAMIC DIGITAL OVERLAYS” filed on Jun. 1, 2023.

The present patent application is also a continuation-in-part of, and claims priority to and the benefit of U.S. patent application Ser. No. 18/673,793 (the '793 application), titled “LARGE FORMAT SOLAR SIGN” and filed May 24, 2024.

The '793 application is a continuation-in-part of, and claims priority to and the benefit of U.S. patent application Ser. No. 18/405,419, titled “LARGE FORMAT SOLAR SIGN” and filed Jan. 5, 2024, which is a continuation of, and claims priority to and the benefit of U.S. patent application Ser. No. 17/696,761 (the '761 application), titled “LARGE FORMAT SOLAR SIGN” and filed Mar. 16, 2022, now U.S. Pat. No. 11,880,060 dated Jan. 23, 2024. The '761 application also claims priority to and the benefit of U.S. Provisional Patent Application No. 63/162,329, titled “LARGE FORMAT SOLAR SIGN” and filed Mar. 17, 2021.

The '793 application is also a continuation-in-part of, and claims priority to and the benefit of U.S. patent application Ser. No. 17/718,212, titled “SYSTEMS AND METHODS FOR FILM-READY SOLAR SIGN” and filed Apr. 11, 2022, which claims priority to and the benefit of U.S. Provisional Patent Application No. 63/173,801, titled “SYSTEMS AND METHODS FOR FILM-READY SOLAR SIGN” and filed Apr. 12, 2021.

Each of these applications is incorporated by reference in its entirety herein.

### FIELD

Aspects of the present disclosure relate generally to solar powered signs that and more particularly to solar powered systems including interchangeable translucent prints illuminated by light sources utilizing solar power.

### BACKGROUND

Signs may be used for various purposes to convey information, such as advertising, marketing, event promotions, vehicular or pedestrian traffic management, and/or the like. Conventional signs often require external light sources to be visible at night. For example, a stop sign may include a border composed of red light-emitting diodes and a post capped with a mounted solar panel. Additionally, such signs are cumbersome, expensive, challenging to manufacture, and not aesthetically appropriate for all contexts. It is with these observations in mind, among others, that various aspects of the present disclosure were conceived and developed.

### SUMMARY

Implementations described and claimed herein address the foregoing by systems and methods for illuminating content. In some implementations, a frame of a solar-powered sign supports a solar sign sheet. A solar panel is disposed relative to the frame. A light source is configured to illuminate the solar sign sheet. A battery is configured to store power generated via the solar panel and provide power to control circuitry configured to control the light source.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 depicts an example dual-sided solar sign.

FIGS. 2A and 2B depict alternate views of the example dual-sided solar sign.

FIG. 3 depicts a side view of the example dual-sided solar sign.

FIG. 4 illustrates a method of operating the solar sign.

FIG. 5 illustrates an exploded view of an example solar sign having a printable surface and a housing.

FIG. 6 illustrates a cross-sectional view of the example solar sign of FIG. 5.

FIG. 7 illustrates an exploded view of an example printable solar sign sheet.

FIG. 8 illustrates a cross-sectional view of the example printable solar sign sheet shown in FIG. 7.

FIG. 9A illustrates a front view of the example printable solar sign sheet.

FIG. 9B illustrates a side view of the example printable solar sign sheet.

FIGS. 10A, 10B, and 10C illustrate diagrams of an example portable toilet system including an example dual-sided solar-powered sign.

FIGS. 11A and 11B illustrate perspective view of an example dual-sided solar-powered sign.

FIGS. 12A, 12B, 12C, and 12D illustrate example diagrams of various components of an example dual-sided solar-powered sign.

FIGS. 13A, 13B, 13C, 13D, 13E, and 13F illustrate example front and back diagrams of example dual-sided solar-powered signs.

### DETAILED DESCRIPTION

Aspects of the presently disclosed technology relate to systems and methods for illuminating content, such a print content, two-dimensional content, three-dimensional content, objects, and/or the like. In some aspects, a self-contained, self-illuminating solar sign includes an integrated solar panel, battery, and control electronics. For example, the solar panel may be located around the frame of the solar panel, allowing for more direct exposure to light, while maintaining a compact footprint. In other examples, the surface of the sign can include a diffusion film that appears white but allows a large amount of light to pass through it and strike the surface of a solar panel embedded in the body of the sign. The surface of the sign can be print-ready, and the entire sign can be manufactured to be fed into a conventional printer, such as a large-format inkjet printer. Thus, the signs described herein can be self-illuminating sheets that are thin (e.g., less than five millimeters thick).

Such solar-powered signs can operate to react to a variety of external conditions, including, but not limited to, weather conditions, light conditions, the position of the sun, movement between indoors and outdoors, as well as general changes in ambient brightness. The internal light source that illuminates the sign can dynamically adjust to compensate for various ambient conditions or to conserve the battery such that the sign may remain lit for a specific duration of time. These changes in brightness can be controlled by changing the intensity of the light source used to illuminate the solar signs. Such light sources may include internal light-emitting diodes (LEDs), which transmit light through an internal light guide of the solar sign to uniformly illuminate the surface of the sign.

In some examples, a solar-powered sign is dual-sided. The solar-powered sign includes a frame, a first solar sign sheet, a second solar sign sheet, a solar panel, and an internal light source configured to illuminate the first solar sign sheet or the second solar sign sheet. The solar-powered sign further includes an internal battery configured to store power generated via the solar panel and provide power to control circuitry configured to control the internal light source.

In some examples, the solar-powered signs may include multiple display surfaces. For example, the solar-powered signs may include multiple light guides that illuminate surfaces with content (e.g., printed graphics) or diffusion films coupled to overlays that include content (e.g., printed and/or other types of graphical features). The solar-powered signs may receive light via one or more surfaces from an external source of light, such as the sun, and utilize the power generated via an internal solar panel to illuminate the multiple internal light sources of the solar-powered sign. One or more internal or external batteries may be utilized to store power generated via the solar panel of the solar-powered sign.

The techniques described in the present disclosure may provide a printable sheet, with no external components. The sheet can be illuminated internally in adverse light conditions, such as at night or during darker conditions. The techniques described herein provide a thin (e.g., less than 5 mm thick, etc.) board with a print ready surface. The print-ready surface can be printed upon using a printer, such as an inkjet printer or a large-format latex inkjet printer.

The printable illuminated sign sheet described herein can include a stack of thin, functional layers. The layer exposed to an external environment can include a diffusion film with micron-scale surface features that facilitate extreme light turning or diffusion. As a result, the surface of the sheet can appear white, when in actuality the sheet can transmit more than 80% of the incident light into the underlying layers. Below the print-ready diffusion surface sits a thin light guide plate (LGP) that emits uniform lighting produced by light emission from edge mounted light sources, such as light-emitting diodes (LEDs). In some examples, a solar panel or film is mounted on or integrated to a frame of the sign sheet. In other examples, the solar panel or film can be coupled to the light guide plate and can be electrically coupled to an electronics module. The electronics module can be in the sign sheet on same layer as, or on a layer proximate to, the solar panel or film in the light illuminated sign sheet.

Sunlight, or another external light, can traverse the diffusion surface of the printable layer and pass through the optically clear LGP and finally contact the underlying solar film or panel, which in turn generates electron flow. These electrons are subsequently forwarded to the internal battery to be stored as power for night illumination.

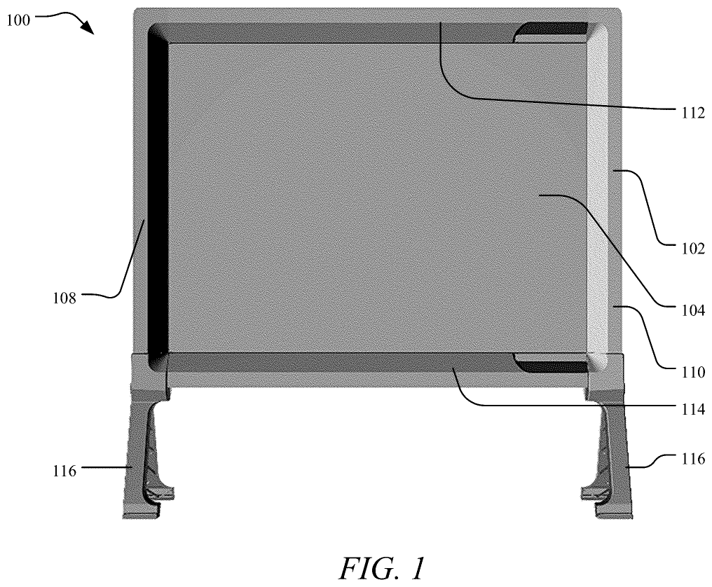

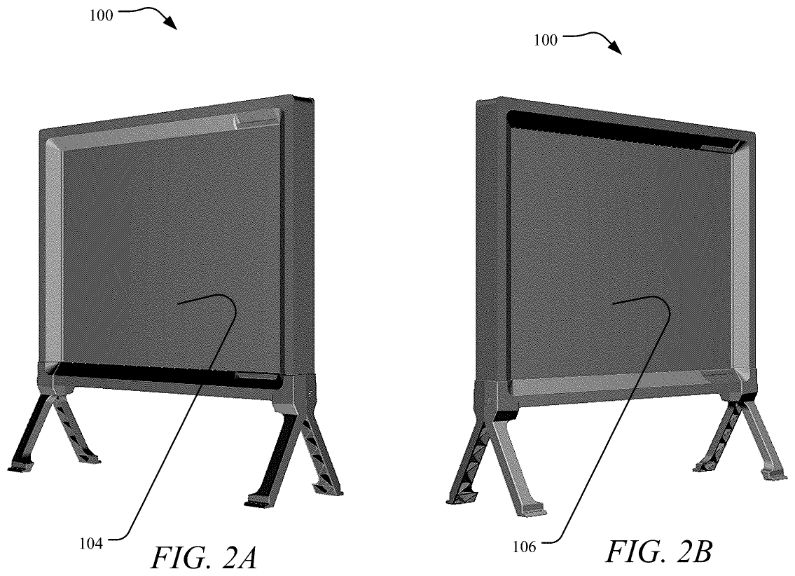

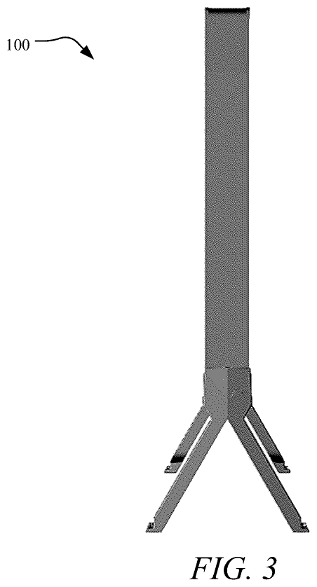

To begin a detailed description of systems and methods for illuminating content, reference is made to FIGS. 1-3, in which a solar sign 100 is depicted. In some implementations, the solar sign 100 includes a frame 102, a first solar sign sheet 104, and a second solar sign sheet 106. The frame 102 further includes first side rail 108, second side rail 110, top rail 112 and bottom rail 114. In some examples, the first side rail 108, second side rail 110, top rail 112 and bottom rail 114 may be integrated into one piece, or they may be formed separately and joined together to form the frame 102. Further, the solar sign 100 includes a support structure 116 which is attached to the frame 102.

In some examples, the solar sign 100 includes a solar panel assembly mounted on an exterior of the frame 102. For example, the solar panel assembly may be mounted in a U-configuration along the first side rail 108, the top rail 112, and the second side rail 110. The solar panel assemblies collect sunlight, or other external light, and generate electricity which can be stored in a battery, as described in further detail below. The battery may be integrated into the solar sign 100. The battery may power light sources of the solar sign to illuminate the sign. The solar sign 100 further includes circuitry designed to selectively turn on the light sources to light the solar sign 100.

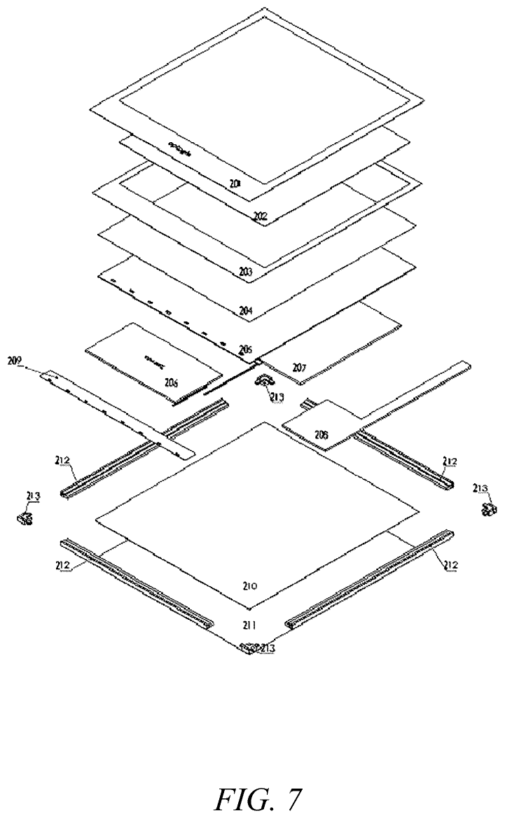

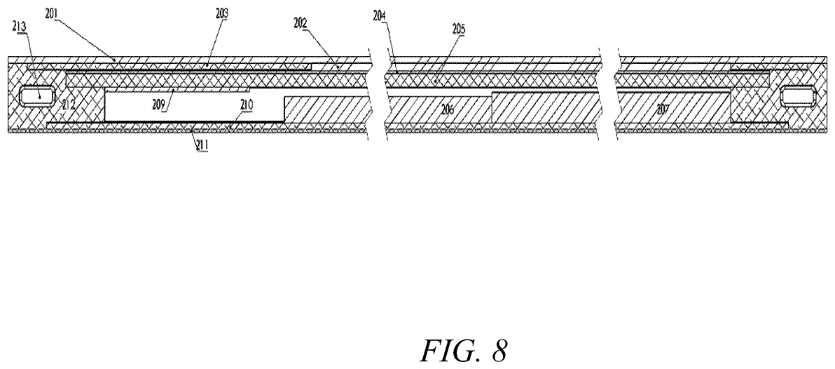

The solar sign 100 includes a dual-sided display including the first solar sign sheet 104 and the second solar sign sheet 106. The first solar sign sheet 104 and the second solar sign sheet 106 are sheets of material configured be printed or otherwise manufactured to include a design that can be illuminated in low-light environments. Example construction of the solar sign sheet is described in further detail with reference to FIGS. 7 and 8.

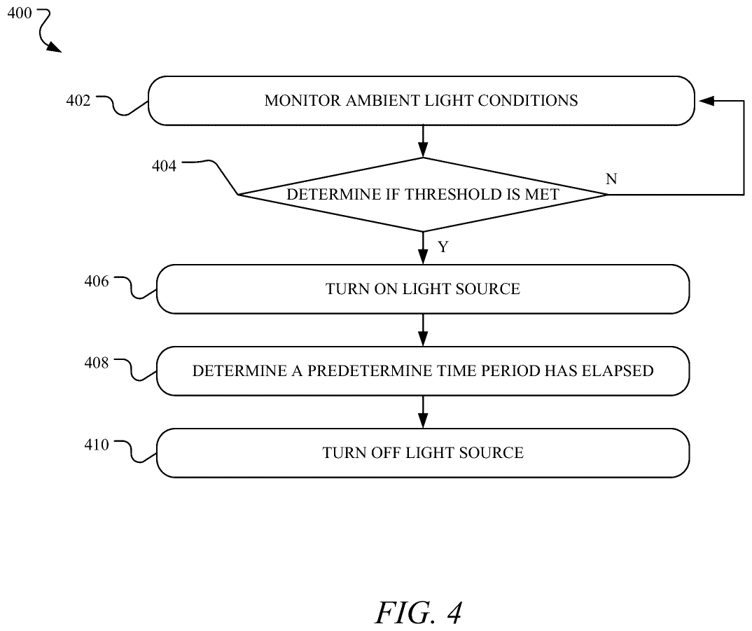

Referring to FIG. 4, example operation 400 of the solar sign 100 is illustrated. In one implementation, an operation 402 monitors light conditions to determine if the solar sign should be illuminated. A processor of the solar sign reads a voltage from the solar panel to determine if the solar panel is receiving light. An operation 404 determines if a predetermined threshold value is met. If the voltage is high enough to exceed the threshold, it is determined that it is daytime, and the sign should not be illuminated and should continue to monitor light conditions. If the voltage does not meet the threshold, an operation 406 tuns on a light source to illuminate the solar sign. An operation 408 then continues to illuminate the solar sign until a predetermined time period elapsed. In some examples, the time period may be 8 hours, which keeps the sign illuminated through a majority of the dark hours but does not unnecessarily consume energy throughout the entire night. An operation 410 turns the light source off after the predetermined period and returns to monitoring light conditions.

Various features can be integrated into the processor to execute different functions of the solar sign. For example, during the time period the sign is illuminated, a brightness can be adjusted (e.g. starting brightness of 100%, incrementally decreasing over the time of operation to 75%). This may be integrated as a way to conserve energy. In other examples, the processor can execute instructions which enable the solar sign to recognize and disregard intermittent low light caused by cloudy weather or thunderstorms. In this example, if the illumination cycle is triggered early by a passing sign, the processor will reset and return to monitoring lights levels.

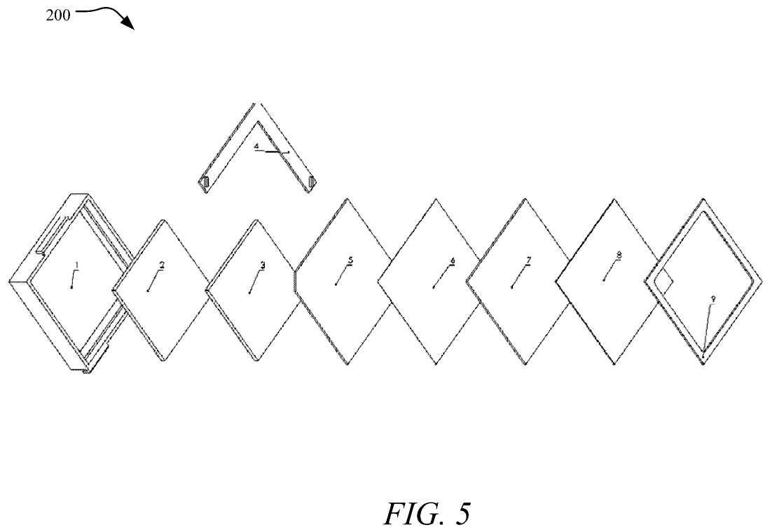

Referring now to FIG. 5, an exploded view of a solar sign 200 is depicted. Dual-sided solar sign 100 may be incorporated to have features similar to those of solar sign 200. In this example, only one solar sign sheet is shown, but in other examples, the solar sign 200 may be a dual-sided design, as described above with reference to dual-sided solar sign 100. The solar sign 200 can include at least one frame 1 (sometimes referred to as a “housing 1” or “base 1”), a battery 2, a solar panel 3, a printed circuit board (PCB) 4, a light guide 5, an inner diffusion film 6, a spacer 7, an outer diffusion film 8, and a border 9. As described herein, each of the components of the solar sign 200 depicted in FIG. 5 can form a portion, or the entirety of, a layer of the solar sign. The layers can be stacked and coupled to one another, for example, using an adhesive or mechanical coupling or connector. In some implementations, the layers can be coupled to one another via mechanical force.

The frame 1 can be a waterproof container that contains each of the layers depicted in FIG. 5. The frame 1 can prevent unwanted materials (e.g., water, dust, debris, etc.) from entering the sign and causing electrical issues or blocking light paths. The frame 1 can be constructed from a polymer material, a metal material, or a composite material. As shown in the exploded view of FIG. 5, each of the components of the solar sign 200 (e.g., the battery 2, the solar panel 3, the printed circuit board (PCB) 4, the light guide 5, the inner diffusion film 6, the spacer 7, the outer diffusion film 8, the border 9, etc.) can be positioned in or coupled to the housing, for example, in one or more layers of a stack. In some examples, some of the components, such as the battery 2, the solar panel 3, the PCB 4, may be mounted on or coupled to the frame 1. The components can be coupled to one another, for example, by one or more mechanical features (e.g., each of the components can be manufactured to fit together tightly within the frame 1, etc.), such as connectors, fasteners, or other mechanical coupling features. In some implementations, one or more of the components of the solar sign 200 can be coupled to one another via an adhesive or other non-mechanical coupling agent. In some implementations, the adhesive can be an optically transparent adhesive. The outer portion of the frame 1 can be coupled to the supporting hardware, such as an A-frame. In some implementations, the frame 1 can include one or more connectors to couple to other solar signs or other support features.

The battery 2 can be a thin, flat battery that can provide electrical power to one or more of the electronic components of the solar sign 200, as described herein. The battery 2 can be a re-chargeable battery, such as a lithium-ion battery, a lithium-polymer battery, a nickel-cadmium battery, or another type of high-density re-chargeable battery with a thin form factor. The battery 2 can receive electric power from the solar panel 3, for example, via charging circuitry present on the PCB 4. The battery 2 can discharge electrical energy through one or more light sources, such as light-emitting diodes, that are present in the solar sign 200. In some implementations, the battery 2 can be positioned in the solar sign 200 such that it is easily removable. In such implementations, the components of the solar sign can fit together such that the solar sign 200 can be disassembled, and the battery 2 can be replaced.

In some examples, the solar panel 3 can be coupled to the battery 2, and the light guide 5, and can absorb light that passes through the outer diffusion film 8, the spacer 7, and the inner diffusion film 6, and the light guide 5. The solar panel 3 can provide electric power to the other components of the solar sign 100 described herein. Light emitted from an external light source (e.g., the sun, etc.) can pass through the layers of the diffusion film, the spacer, and the light guide 5, and contact the surface of the solar panel 3. Photons in the light can be absorbed by the solar panel 3 and converted into an electron flow that is stored in the battery 2 (e.g., via power circuitry on the PCB 4, etc.). The solar panel 3 can be any sort of photovoltaic cell or photovoltaic film having a thin form factor. The solar panel 3 can be constructed from semiconducting materials, such as doped silicon.

As described above, with reference to FIGS. 1-3, the solar panel 3 may be incorporated into an exterior of the frame 1. In some examples, the solar panel 3 may form be U-shaped and form to the shape of the frame 1 to take advantage of the exterior surface area of the frame 1 so that the light comes into direct contact with the solar panel 3.

The battery 2 can store a charge over the course of a day (e.g., via the solar panel 3 absorbing energy from an external light source, etc.). Then, in circumstances of low light (e.g., each evening if the solar sign is positioned outside, etc.), the solar panel 3 can generate a decreased electron flow (e.g., a decreased voltage from what was produced during periods of high external light, etc.)

The PCB 4 can include electronics, such as power electronics that can control the flow of electrons output by the solar panel 3. As described herein above, the PCB 4 can be electrically coupled to the solar panel 3 via one or more electrical connections (not shown). The PCB 4 can include one or more voltage sensors that can monitor voltage signals produced by the solar panel 3. In some implementations, the PCB 4 can include one or more voltage sensors that monitor the voltage level of the battery. For example, each of the voltage sensors can output a signal (e.g., an electrical signal, etc.) that indicates an amount of voltage generated by the solar panel 3 or the battery 2. The signals can be received, for example, by a controller on the PCB 4.

The PCB 4 can include one or more light sources that can illuminate the solar sign 200 via the light guide 5 (described in further detail herein). The light sources can be any sort of light source that can emit light in response to receiving electric energy. The light sources can be electrically coupled to and receive electric power from the battery, for example, via power circuitry (e.g., voltage converters, etc.) on the PCB 4. The light sources can emit light with an intensity that is proportional to the amount of electric power received from the power circuitry. Thus, the power circuitry can control the amount of electric power provided to the light sources, and thus the amount of light emitted by the light sources. The light sources can have a thickness that corresponds (e.g., about equal to, less than, etc.) to a thickness of the light guide 5. The light sources can be, for example, one or more LEDs or any other type of light source. The light source can be a bright source of light that uses a low amount of power.

The PCB 4 can include a controller that can monitor voltage signals produced by the voltage sensors and provide power controls to the electronic components (e.g., the light sources, the solar panel 3, etc.) of the solar sign 200. The controller can include at least one processor and a memory (e.g., a processing circuit, etc.). The memory can store processor-executable instructions that, when executed by processor, cause the processor to perform one or more of the operations described herein. The processor can include a microprocessor, a microcontroller, an application-specific integrated circuit (ASIC), a field-programmable gate array (FPGA), a graphics processing unit (GPU), etc., or combinations thereof. The memory can include, but is not limited to, electronic, optical, magnetic, or any other storage or transmission device capable of providing the processor with program instructions. The memory can further include a memory chip, ASIC, FPGA, read-only memory (ROM), random-access memory (RAM), electrically erasable programmable ROM (EEPROM), erasable programmable ROM (EPROM), flash memory, optical media, or any other suitable memory from which the processor can read instructions. The instructions can include code from any suitable computer programming language.

The processor of the electronics module can receive signals (e.g., via an interconnect or other communications bus, etc.) from the voltage sensors on the PCB 4 that correspond to the amount of light being received by the solar panel 3. Based on the amount of light received from the solar panel 3, the processor can provide signals to one or more switches (e.g., transistors, integrated circuits, etc.) that cause the battery 2 to provide electric power to the light sources connected to the PCB 4. For example, if the processor detects that the amount of voltage produced by the solar panel 3 has fallen below a predetermined threshold, the processor can determine that the solar sign 200 is not properly or completely illuminated. Based on the signals from the voltage sensors, the processor can determine whether the amount of light striking the solar panel 3 represents a temporary blockage (e.g., an external light source is obscured temporarily, etc.), of the amount of light striking the solar panel 3 represents that the solar sign 200 is now in a dark environment (e.g., it is now night time, or the solar sign has been moved to a dark room, etc.). The processor can compensate for the low light levels by transitioning form an unilluminated (e.g., the light source is not receiving power, etc.) state to an illuminated (e.g., the light source is receiving power, etc.) state.

The processor can provide (e.g., via the power circuitry, transistors, switches, etc.) an amount of power that is proportional to the amount of light required to illuminate the solar sign 200. In some implementations, the processor can store information about the amount and the color of one or more graphical designs or printed images printed on the outer surface of the outer diffusion film 8. For darker images with more ink, the processor can provide more electric power to the light sources, thus providing more light to illuminate the darker graphic. Likewise, if a graphic on the solar sign 200 is absent, or has light or small amounts of ink, the processor can provide slightly less electric power to the light sources, thus providing uniform illumination for the solar sign 200.

In some examples, the light guide 5 can be positioned adjacent to the solar panel 3, such that light passing through the light guide can strike the solar panel 3 and generate electric power. The light guide 5 can be a transparent plate of material that can both receive and guide light from one or more light sources, such as the light sources on the PCB 4 or an external light source, such as the sun. As described herein, the surface of the light guide 5 (e.g., the surface coupled to the inner diffusion film 6, etc.) can include one or more light extraction features, such as lenses or lenslets. In some implementations, the surface of the light guide 5 opposite the surface coupled to the inner diffusion film 6 can include one or more light exaction features. The light extraction features can extract a portion of the light injected into the light guide 5, such as the light emitted by the light sources on the PCB 4. The light guide 5 can guide another portion of the light injected into the light guide towards an opposite edge of the light guide 5. The light extraction features can be precisely placed across the surface of the light guide 5 in a predetermined pattern, such that light is uniformly extracted, and thus emitted, across the entire surface of the light guide 5. Thus, the light guide 5 can uniformly illuminate the other layers of the solar sign (e.g., the inner diffusion film 6, the spacer 7, the outer diffusion film 8, etc.), including any graphical designed printed on the outer diffusion film.

The light guide 5 can be optically coupled to the light sources in the solar sign. In some implementations, the light sources can be positioned within a cavity formed in the light guide 5. The light source can emit light through the cavity and into the body of the light guide 5, thereby injecting light into the light guide 5. In some implementations, the light guide 5 does not include a cavity, and instead is a uniform rectangular plate that can receive light emitted from the light source via an edge of the light guide 5. In such implementations, the light sources can be positioned external to the light guide 5 and inject light into the light guide plate via the edge. The light guide 5 can have a shape that accommodates the light sources, for example, having one or more edges or corners that are “clipped” or removed from a uniform rectangular plate, as shown in FIG. 5.

The inner diffusion film 6 can be a sheet of partially transparent film that has a first surface coupled to a spacer 7 (e.g., which can be a transparent plastic spacer, for example, to achieve a desired structural thickness, etc.) and a second surface that is coupled to the light guide 5. The inner diffusion film 6 can be a partially transparent film that appears white, or another solid color, while still allowing an amount of light to pass through the diffusion film and into the light guide 5. For example, light emitted by an external light source (e.g., the sun, etc.) can pass through both the outer diffusion film 8, the spacer 7, and the inner diffusion film 6, striking the solar panel 3 where it is absorbed. The inner diffusion film 6 can be uniformly illuminated by the light extracted by the light extraction features of light guide 5, such that the solar sign and any graphical designs printed thereon can be illuminated in low-light environments (e.g., at night time, etc.). In some implementations, the inner diffusion film 6 can have greater than 70% angular diffusion. In some implementations, the inner diffusion film 6 can have a light transmission rate that exceeds 80%. The inner diffusion film can aid in the operation of the light guide 5, which in some implementations can provide a more uniformly distributed light pattern when exposed to air. The inner diffusion film 6 can have a rough surface, and thus when coupled to the light guide 5, the majority of the surface of the light guide 5 is exposed directly to air, because the rough surface of the inner diffusion film 6 is not uniform or perfectly flat.

The spacer 7 can be a thin, flat portion of plastic that acts as a buffer between the inner diffusion film 6 and the outer diffusion film 8. The spacer 7 can be manufactured from a transparent material, such as glass, a transparent acrylic, or another type of transparent plastic. The spacer 7 can have similar dimensions to the inner diffusion film 6 and the outer diffusion film 8. The spacer 7 can have a thickness selected to allow each of the components of the solar sign to fit together in the frame 1 of the solar sign 200. The spacer 7 can have high transmissivity, such that light easily passes through the spacer 7. The spacer 7 can allow light diffused from the inner diffusion film 6 to pass largely uninterrupted to the outer diffusion film 8, thereby illuminating the solar sign 200. Likewise, the spacer 7 can receive light from an external light source (e.g., the sun, etc.) via the outer diffusion film 8, and allow the light to pass largely uninterrupted through the inner diffusion film 6, striking the solar panel 3.

The outer diffusion film 8 can be a sheet of partially transparent film that has a first surface exposed to an external environment and a second surface that is coupled to the spacer 7. The outer diffusion film 8 can include a light-turning imprinted surface (e.g., the surface facing the external environment, etc.). The outer diffusion film 8 can include a partially transparent surface that appears white, or another solid color, while still allowing an amount of light to pass through the diffusion film and into the light guide 5. Light from an external light source (e.g., the sun, etc.) can pass through the outer diffusion film 8, the spacer 7, the inner diffusion film 6, and the light guide 5, striking the solar panel 3 where it is absorbed. The outer diffusion film 8 can be a printable film, such that the outer diffusion film 8 can be made from a material to which printer ink can be directly applied. Thus, in some implementations, the solar sign 200 can be passed through a printer, such as a wide format inkjet printer, which can print ink directly onto the outer diffusion film 8 of the solar sign 200. The solar sign 200 can be placed on or coupled to a template that guides the solar sign 200 through the printer to facilitate the printing process.

The outer diffusion film 8 can be printed using a latex ink, a black ink, a white ink, or any other semi-transparent ink. The outer diffusion film 8 can be uniformly illuminated by the light extracted by the light extraction features of light guide 5, such that the solar sign 200 and any graphical designs printed thereon can be illuminated in low-light environments (e.g., at night time, etc.). In some implementations, and as described herein above, the outer diffusion film 8 can be coupled to an overlay film such that the illuminated outer diffusion film 8 provides uniform illumination through the overlay film. In some implementations, the outer diffusion film 8 can be easily removable and replaceable from the frame 1. Thus, different designs for the solar sign 200 can easily be changed by exchanging the outer diffusion films 8 having graphical designs printed thereon.

The border 9 can provide a weatherproof border for the exposed edges of the solar sign 200, surrounding the outer diffusion film 8. As shown, the outer diffusion film 8 can be exposed to the external environment through the large opening in the border 9. The border 9 can be manufactured from a material similar to that used to manufacture the frame 1. The border 9 can be coupled to the border 9 to create a weatherproof seal, thereby preventing water, dust, or other debris from interfering with the internals of the solar sign 200. In some implementations, the border 9 can be removable, such that the outer diffusion film 8 can be easily removed and replaced. This can allow for different designs to be displayed on the same sign by exchanging different outer diffusion films 8 having different designs printed thereon. In some implementations, the frame 1 can include one or more brackets or connectors that couple the solar sign 200 to a frame. The frame can position the printable solar sign at a predetermined angle from a light source, such as the sun. In doing so, the frame can position the solar sign such that the sign appears flat to a viewer (e.g., completely upright), while still absorbing a large percentage of light emitted by an external light source.

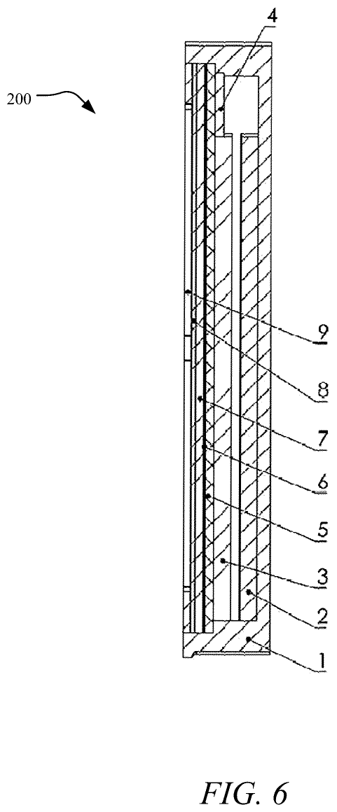

Referring now to FIG. 6, illustrated is a cross-sectional view of the solar sign 200 shown in FIG. 5, in accordance with one or more implementations. As shown in the cross-sectional view, each of the layers in the solar sign 200 can be pressed against one another firmly, such that they are fixed in place in the frame 1 of the solar sign 200. Also as shown, each of the components can fit within the frame 1 such that the components are coupled to the frame 1, for example, via mechanical or frictional force. In some implementations, an adhesive can be disposed between one or more of the layers of the solar sign 200. In some implementations, the adhesive can be an optically transparent adhesive with a similar index of refraction to other components of the solar sign 200 (e.g., the light guide 5, etc.). Each of the components of the solar sign 200 can be placed in the base in a particular order. As shown, the frame 1 can form a housing for the sign and can include one or more attachment or guiding features (e.g., grooves, slots, etc.) into which the other components of the solar sign 200 can fit or connect.

The battery 2 can first be positioned near the bottom of the frame 1. In some implementations, the battery 2 can fit into one or more slots, grooves, or recessed portions of the frame 1. Next, the solar panel 3 can be positioned top of, or adjacent to, the battery 2. As described above, the solar panel 3 may also be positioned around the exterior of the frame 1. The solar panel 3 can be electrically coupled to the battery 2. The PCB 4 can then be positioned in the frame 1 adjacent to the solar panel 3. The PCB 4 can be positioned such that any light sources present on the PCB 4 will be aligned with the light guide 5 when the light guide 5 is positioned in the solar sign 200. The light guide 5 can be positioned on top of the solar panel 3, such that light passing through the light guide 5 from an external light source can be passed to the surface of the solar panel 3. Further, the light guide 5 can be positioned in the frame 1 such that an edge of the light guide 5 can receive light from a light source, such as a light source positioned on or electrically coupled to the PCB 4. In some implementations, the light source can be electrically coupled to but physically separate from the PCB 4 (e.g., on a separate circuit board module, etc.).

The inner diffusion film 6 can be positioned on top of the light guide 5, such that the light emitted from the light sources and extracted by the light extraction features on the surface of the light guide 5 is diffused through the inner diffusion film, thereby evenly illuminating the solar sign. The spacer 7 can be positioned on top of the inner diffusion film 6. As shown, the spacer can provide additional depth to the stack of functional components of the solar sign 200 and provide a buffer through which light from the outer diffusion film 8 can pass before reaching the inner diffusion film 6. The outer diffusion film 8 can be positioned on top of the spacer 7. As described herein above, the outer diffusion film 8 can include a printable surface exposed to the external environment. Inks such as latex inks, or other types of inks, can be printed directly onto the printable surface of the outer diffusion film 8. Finally, the border 9 can create a seal between the outer diffusion film 8 and the frame 1, thereby creating a weatherproof, printable sign. It should be understood that the various signs described herein can be scaled to any appropriate dimension, and the entire sign as pictured in FIGS. 5 and 6 can have a profile passable through a printer such that the printer can print on the outer diffusion film 8.

Referring now to FIG. 7, illustrated is an exploded view of an example printable solar sign sheet, in accordance with one or more implementations. The solar sign sheet shown in FIG. 7 can be used in the dual-sided solar sign 100 depicted in FIGS. 1-3. The solar sign sheet shown in FIG. 7 can be a stack of functional materials, similar to the printable solar sign depicted in FIGS. 5 and 6. The printable solar sign shown in the exploded view can include a top diffusion film 201, a spacer 202, a border 203, an inner diffusion film 204, a light guide 205, a battery 206, a solar panel 207, a filler 208, a PCB 209, a back plate 210, vinyl 211, a rail 212, and a corner piece 213. In some examples, the solar panel 207 may be located on the exterior of the frame, and therefore, not included in the solar sign sheet. As described herein, each of the components of the solar sign depicted in FIG. 7 can form a portion, or the entirety of, a layer of the printable solar sign. The components can be coupled together, for example, via an adhesive or mechanical connectors, to form a sheet of layered, functional components. In some implementations, the layers can be coupled to one another via mechanical force such as friction.

The printable solar sign, including all of the components outlined above, can have a sheet structure that is thin, for example, less than five millimeters thick. The solar sign can be fed into a printer, for example, a wide format inkjet printer. Some examples of wide-format inkjet printers include the HP R1000 or the HP R2000 large-format latex inkjet printer. Said printers can print latex ink on the surface of the top diffusion film 201, thereby creating a design on the sign that can be illuminated in low-light environments. The design can be printed using a latex ink. Thus, the solar sign described herein can be an opto-electronic print media.

Starting from the bottom of the stack of functional components, the corner piece 13 and the rails 212 can form portions of the edges of the solar sign. The corner piece can include one or more pegs, or other types of connectors, that allow the corner piece 213 to be connected to two of the rails 212. Four corner pieces 13 can be used in conjunction with four rails 212 to define the edges of the solar sign. The corner pieces 13 and the rails 212 can be formed from any suitable material, for example, a polymer material, a metal material, or a composite material. In some implementations, the rails can be formed from aluminum or steel. In some implementations, the corner pieces 13 and the rails 212 can include one or more grooves, slots, or recesses into which one or more of the components of the solar sign can rest or be coupled. In some implementations, the rails 212 and the corner pieces can couple to the back plate 210. The vinyl 211 can be a sheet of vinyl that covers the back portion of the rails 212, the corner pieces 213, and the back plate 210, creating a weatherproof seal across the bottom of the solar sign. The back plate 210 can be a rigid plate onto which the other layers of the solar sign are stacked or coupled. The back plate 210 can be formed from any suitable material, including plastics, metals, or composite materials.

The battery 206, the solar panel 207, the filler 208, and the PCB 209 can together form the next layer of the solar sign. As described above, in some examples, solar panel 207 may instead be located on the exterior of the frame. The battery 206 can be similar to and include any of the structure of functionality of the battery 2 described herein above in connection with FIGS. 5 and 6. The battery 206 can be a thin, flat battery that can provide electrical power to one or more of the electronic components of the solar sign, as described herein. The battery 206 can be a re-chargeable battery, such as a lithium-ion battery, a lithium-polymer battery, a nickel-cadmium battery, or another type of high-density re-chargeable battery with a thin form factor. In some implementations, the battery 206 can be less than about 3 millimeters thick. The battery 206 can receive electric power from the solar panel 207, for example, via charging circuitry present on the PCB 209. The battery 206 can discharge electrical energy through one or more light sources, such as light-emitting diodes, that are present in the solar sign. In some implementations, the battery 206 can be positioned in the solar sign such that it is easily removable. In such implementations, the components of the solar sign can fit together such that the solar sign can be disassembled, and the battery 206 can be replaced.

Likewise, the solar panel 207 can be similar to and include any of the structure and functionality of the solar panel 3 described herein above in connection with FIGS. 5 and 6. The solar panel 207 can be coupled to the battery 2, and the light guide 205, and can absorb light that passes through the outer diffusion film 8, the spacer 7, and the inner diffusion film 6, and the light guide 205. The solar panel 207 can provide electric power to the other components of the solar sign described herein. Light emitted from an external light source (e.g., the sun, etc.) can pass through the layers of the diffusion film, the spacer, and the light guide 205, and contact the surface of the solar panel 207. Photons in the light can be absorbed by the solar panel 207 and converted into an electron flow that is stored in the battery 206 (e.g., via power circuitry on the PCB 4, etc.). The battery 2 can store a charge over the course of a day (e.g., via the solar panel 207 absorbing energy from an external light source, etc.). Then, in circumstances of low light (e.g., each evening if the solar sign is positioned outside, etc.), the solar panel 207 can generate a decreased electron flow (e.g., a decreased voltage from what was produced during periods of high external light, etc.) The solar panel 207 can be any sort of photovoltaic cell or photovoltaic film having a thin form factor. The solar panel 207 can be constructed from semiconducting materials, such as doped silicon.

The PCB 209 can be similar to and include any of the structure and functionality of the PCB 209 described herein in connection with FIGS. 5 and 6. The PCB 209 can include electronics, such as power electronics that can control the flow of electrons output by the solar panel 207. As described herein above, the PCB 209 can be electrically coupled to the solar panel 207 via one or more electrical connections (not shown). The PCB 209 can include one or more voltage sensors that can monitor voltage signals produced by the solar panel 207. In some implementations, the PCB 209 can include one or more voltage sensors that monitor the voltage level of the battery 206. For example, each of the voltage sensors can output a signal (e.g., an electrical signal, etc.) that indicates an amount of voltage generated by the solar panel 207 or the battery 206. The signals can be received, for example, by a controller on the PCB 209.

The PCB 209 can include one or more light sources that can illuminate the solar sign via the light guide 205 (described in further detail herein). In some implementations, the one or more light sources can be physically separate from but still electrically coupled to the PCB 209, and any components thereof (e.g., the processor, power electronics, switches, etc.). The light sources can be any sort of light source that can emit light in response to receiving electric energy. The light sources can be electrically coupled to and receive electric power from the battery, for example, via power circuitry (e.g., voltage converters, etc.) on the PCB 209. The light sources can emit light with an intensity that is proportional to the amount of electric power received from the power circuitry. Thus, the power circuitry can control the amount of electric power provided to the light sources, and thus the amount of light emitted by the light sources. The light sources can have a thickness that corresponds (e.g., about equal to, less than, etc.) to a thickness of the light guide 205. The light sources can be, for example, one or more LEDs or any other type of light source. The light source can be a bright source of light that uses a low amount of power.

In some implementations, the PCB 209 can include one or more magnetic sensors. The magnetic sensors can be electrically coupled to one or more components of the PCB 209 (e.g., the processor, the power circuitry, etc.). The magnetic sensors can provide a signal to the components of the PCB 209 in response to sensing a magnetic field, for example, from a magnet positioned on a frame configured to hold the solar sign. The signal from the magnetic sensor can enable the use of the solar sign. Said another way, the solar sign can be used in connection with authorized frames that have magnets appropriately positioned to activate the magnetic sensors of the PCB 209. Once activated, the magnetic sensors can provide a signal that allows the sign to operate as intended (e.g., absorb light from the sun to charge the battery 206, and illuminate the sign in low-light environments, etc.). In some implementations, an electromagnetic sensor can be electrically coupled to the PCB 209. The electromagnetic radiation sensor can detect electromagnetic radiation emitted, for example, by an overlay film (e.g., similar to the top diffusion film 201, etc.) having an electromagnetic radiation source positioned thereon. Similar to the operation of the magnetic sensor, the electromagnetic radiation sensor can detect electromagnetic radiation from authorized overlay films. The electromagnetic radiation sensor can produce a signal that activates the other components of the PCB 209, allowing the solar sign to operate as intended, in response to detecting an electromagnetic radiation signal from an authorized solar sign. Such electromagnetic radiation signals can include, for example, a near-filed communication (NFC) signal, a Bluetooth signal, or any other type of electromagnetic radiation signal. The overlay film can be an optically clear sheet of film, and can include a printed surface. The overlay film can be positioned over the external surface of the top diffusion film 201.

The PCB 209 can include a controller that can monitor voltage signals produced by the voltage sensors and provide power controls to the electronic components (e.g., the light sources, the solar panel 207, etc.) of the solar sign. The controller (e.g., the computing system 600 of FIG. 7) can include at least one processor and a memory (e.g., a processing circuit, etc.). The memory can store processor-executable instructions that, when executed by processor, cause the processor to perform one or more of the operations described herein. The processor can include a microprocessor, a microcontroller, an ASIC, an FPGA, a GPU, etc., or combinations thereof. The memory can include, but is not limited to, electronic, optical, magnetic, or any other storage or transmission device capable of providing the processor with program instructions. The memory can further include a memory chip, ASIC, FPGA, ROM, RAM, EEPROM, EPROM, flash memory, optical media, or any other suitable memory from which the processor can read instructions. The instructions can include code from any suitable computer programming language.

The processor of the PCB 209 can receive signals (e.g., via an interconnect or other communications bus, etc.) from the voltage sensors on the PCB 209 that correspond to the amount of light being received by the solar panel 207. Based on the mount of light received from the solar panel 207, the processor can provide signals to one or more switches (e.g., transistors, integrated circuits, etc.) that cause the battery 206 to provide electric power to the light sources connected to the PCB 209. For example, if the processor detects that the amount of voltage produced by the solar panel 207 has fallen below a predetermined threshold, the processor can determine that the solar sign is not properly or completely illuminated. Based on the signals from the voltage sensors, the processor can determine whether the amount of light striking the solar panel 207 represents a temporary blockage (e.g., an external light source is obscured temporarily, etc.), of the amount of light striking the solar panel 207 represents that the solar sign is now in a dark environment (e.g., it is now night time, or the solar sign has been moved to a dark room, etc.). The PCB 209 can include or may be in communication with the computing system (e.g., which may be included in the solar sign). The processor(s) of the PCB can perform any of the functionalities described in connection with FIGS. 1-13.

The processor can compensate for the low light levels by transitioning form an unilluminated (e.g., the light source is not receiving power, etc.) state to an illuminated (e.g., the light source is receiving power, etc.) state. The processor can provide (e.g., via the power circuitry, transistors, switches, etc.) an amount of power that is proportional to the amount of light required to illuminate the solar sign. In some implementations, the processor can store information about the amount and the color of one or more graphical designs or printed images printed on the outer surface of the outer diffusion film 8. For darker images with more ink, the processor can provide more electric power to the light sources, thus providing more light to illuminate the darker graphic. Likewise, if a graphic on the solar sign is absent, or has light or small amounts of ink, the processor can provide slightly less electric power to the light sources, thus providing uniform illumination for the solar sign.

The filler 208 can fill the empty space between the other components in the layer formed by the battery 206, the solar panel 207, and the PCB 209. As shown, each of the battery 206, the solar panel 207, and the PCB 209 can be sized such that each has a similar thickness, and fit together on a single layer or plane. However, in some cases, additional space between the battery 206, the solar panel 207, the PCB 209, and the edges of the sheet (e.g., defined by the rails 212 or other edge pieces, etc.). The filler 208 can be sized to fill in the gaps formed between the battery 206, the solar panel 207, and the PCB 209 to complete a flat structural layer on top of the back plate 210. The filler 208 can be formed from any suitable non-conductive material, such as plastic, foam, or any other type of filler material. The filler 208 can have substantially similar (e.g., plus or minus 10%) thickness to the battery 206, the solar panel 207, and the PCB 209. Thus, the filler 208 can be used to form a complete layer with the battery 206, the solar panel 207, and the PCB 209 across the entire back plate 210. In some implementations, in addition or as a part of the filler 208, a board with cutouts to hold components, including the PCB 209 (e.g., and any electronics forming a part of the PCB 209, etc.). The board can be manufactured from any suitable material, such as a corrugated plastic material. The board can have a surface color that is similar to the surface color of the solar panel 207. In some implementations, an additional colored film can be positioned on this layer above the PCB 209, the battery 206, or the filler 208, or any combination thereof. The colored film can have a similar color to that of the solar panel 207.

The next layer in the stack can be formed from the light guide 205. The light guide 205 can be similar to and include any of the functional or structural features of the light guide 205 described herein in connection with FIGS. 5 and 6. The light guide 205 can be positioned adjacent to the solar panel 207, such that light passing through the light guide 205 can strike the solar panel 207 and generate electric power. The light guide 205 can be a transparent plate of material that can both receive and guide light from one or more light sources, such as the light sources on the PCB 209 or an external light source, such as the sun. As described herein, the surface of the light guide 205 (e.g., the surface coupled to the inner diffusion film 204, etc.) can include one or more light extraction features, such as lenses or lenslets. In some implementations, the surface of the light guide 205 opposite the surface coupled to the inner diffusion film 204 can include one or more light exaction features. The light extraction features can extract a portion of the light injected into the light guide 205, such as the light emitted by the light sources on the PCB 209. The light guide 205 can guide another portion of the light injected into the light guide towards an opposite edge of the light guide 205. The light extraction features can be precisely placed across the surface of the light guide 205 in a predetermined pattern, such that light is uniformly extracted, and thus emitted, across the entire surface of the light guide 205. Thus, the light guide 205 can uniformly illuminate the other layers of the solar sign (e.g., the inner diffusion film 204, the top diffusion film 201, etc.), including any graphical designed printed on the outer diffusion film.

The light guide 205 can be optically coupled to the light sources in the solar sign. In some implementations, the light sources can be positioned within a cavity formed in the light guide 205. In some implementations, the cavity can be a hole in the light guide 205 into which the one or more light sources are inserted. The light source can have a thickness that is similar to or less than the thickness of the light guide 205. The light source can emit light through the cavity and into the body of the light guide 205, thereby injecting light into the light guide 205. In some implementations, the light guide 205 does not include a cavity, and instead is a uniform rectangular plate that can receive light emitted from the light source via an edge of the light guide 205. In such implementations, the light sources can be positioned external to the light guide 205 and inject light into the light guide plate via the edge.

The next layer in the solar sign can be formed from the inner diffusion film 204. The inner diffusion film 204 can be similar to and include any of the functional and structural features of the inner diffusion film 6 described herein in connection with FIGS. 5 and 6. The inner diffusion film 204 can be a sheet of partially transparent film that has a first surface coupled to a border 203 and the spacer 202 (e.g., which can be a transparent plastic spacer, for example, to achieve a desired structural thickness, etc.), and a second surface that is coupled to the light guide 205. The inner diffusion film 204 can be a partially transparent film that appears white, or another solid color, while still allowing an amount of light to pass through the diffusion film and into the light guide 205. For example, light emitted by an external light source (e.g., the sun, etc.) can pass through both the top diffusion film 201, the spacer 202, and the inner diffusion film 204, striking the solar panel 207 where it is absorbed. The inner diffusion film 204 can be uniformly illuminated by the light extracted by the light extraction features of light guide 205, such that the solar sign and any graphical designs printed thereon can be illuminated in low-light environments (e.g., at night time, etc.). In some implementations, the inner diffusion film 204 can have greater than 70% angular diffusion. In some implementations, the inner diffusion film 204 can have a light transmission rate that exceeds 80%. The inner diffusion film can aid in the operation of the light guide 205, which in some implementations can provide a more uniformly distributed light pattern when exposed to air. The inner diffusion film 204 can have a rough surface, and thus when coupled to the light guide 205, the majority of the surface of the light guide 205 is exposed directly to air, because the rough surface of the inner diffusion film 204 is not uniform or perfectly flat.

The next layer in the solar sign can be formed from the border 203 and the spacer 202. The border 203 can provide a weatherproof border for the exposed edges of the solar sign, while surrounding the spacer 202. The spacer 202 can be positioned in the large opening of the border 203, and the spacer 202 and the border 203 can each be coupled to the inner diffusion film 204, described herein above. The border 203 can be manufactured from any suitable material, such as a plastic, rubber, metal, or composite material. In some implementations, the border 203 can be opaque. The spacer 202 can be a thin, flat portion of plastic that acts as a buffer between the inner diffusion film 204 and the top diffusion film 201. The spacer 202 can be manufactured from a transparent material, such as glass, a transparent acrylic, or another type of transparent plastic. The spacer 202 can have dimensions smaller than the inner diffusion film 204, such that the spacer 202 can fit snugly in the large opening of the border 203. Together, the spacer 202 and the border 203 can form a single layer having similar dimensions to the light guide 205. The spacer 202 can have a thickness similar to the thickness of the border 203. The spacer 202 can have high transmissivity, such that light easily passes through the spacer 202. The spacer 202 can allow light diffused from the inner diffusion film 204 to pass largely uninterrupted to the top diffusion film 201, thereby illuminating the solar sign. Likewise, the spacer 202 can receive light from an external light source (e.g., the sun, etc.) via the top diffusion film 201, and allow the light to pass largely uninterrupted through the inner diffusion film 204, striking the solar panel 207.

The top layer of the printable solar sheet can be formed from the top diffusion film 201. The top diffusion film 201 can include any of the functional or structural features of the outer diffusion film 8 described herein in connection with FIGS. 5 and 6. The top diffusion film 201 can be a sheet of partially transparent film that has a first surface exposed to an external environment and a second surface that is coupled to the spacer 202 and the border 203. The top diffusion film 201 can include a light-turning imprinted surface (e.g., the surface facing the external environment, etc.). The top diffusion film 201 can include a partially transparent surface that appears white, or another solid color, while still allowing an amount of light to pass through the diffusion film and into the light guide 205. Light from an external light source (e.g., the sun, etc.) can pass through the top diffusion film 201, the spacer 202, the inner diffusion film 204, and the light guide 205, striking the solar panel 207 where it is absorbed. The top diffusion film 201 can be a printable film. The top diffusion film 201 can be made from a material to which printer ink can be directly applied. Thus, in some implementations, the solar sign (e.g., including the stack of one or more of the layers, etc.) can be passed through a printer, such as a wide format inkjet printer, which can print ink directly onto the top diffusion film 201 of the solar sign. The solar sign can be placed on or coupled to a template that guides the solar sign through the printer to facilitate the printing process.

The top diffusion film 201 can be printed on using a latex ink, a colored latex ink, a black ink, a white ink, or any other semi-transparent ink. The top diffusion film 201 can be uniformly illuminated by the light extracted by the light extraction features of light guide 205, such that the solar sign and any graphical designs printed thereon can be illuminated in low-light environments (e.g., at night time, etc.). In some implementations, and as described herein above, the top diffusion film 201 can be coupled to an overlay film such that the illuminated top diffusion film 201 provides uniform illumination through the overlay film. In some implementations, the top diffusion film 201 can be easily removable and replaceable. Thus, different designs for the solar sign can easily be changed by exchanging the top diffusion films 201 having different designs printed thereon.

Referring now to FIG. 8, illustrated is a cross-sectional view of the example printable solar sign sheet of FIG. 7, in accordance with one or more implementations. As shown in the cross-sectional view, each of the layers in the solar sign can be pressed against one another firmly, such that they are fixed in place in the frame 1 of the solar sign. Also as shown, each of the components can fit within a housing or sheet structure, formed from the rails 212 (e.g., defining the edges of the sheet, etc.), the corner pieces 213 (e.g., defining the corners of the sheet, etc.), and the back plate 210 (e.g., forming the back of the sheet). To enhance weatherproofing and aesthetic appearance, a sheet of the vinyl 211 can cover any gaps formed between the corner pieces 213, the rails 212, and the back plate 210.

The components forming the layers of the solar sign can sit within the base formed from the back plate 210, the rails 212, and the corner pieces 213. In some implementations, an adhesive can be disposed between one or more of the layers of the solar sign. In some implementations, the adhesive can be an optically transparent adhesive with a similar index of refraction to other components of the solar sign (e.g., the light guide 205, etc.). Each of the components of the solar sign can be placed in the base in a particular order. As shown, the base can form a housing for the sign. In some implementations, the base can include one or more attachment or guiding features (e.g., grooves, slots, etc.) into which the other components of the solar sign can fit or connect.

The battery 206, the solar panel 207, the PCB 209, and the filler 208 can first be positioned near the bottom of the base, and can form the first layer of the printable solar sign. In some implementations, the battery 206 can fit into one or more slots, grooves, or recessed portions of the solar sign. The solar panel 207 and the PCB 209 can be positioned adjacent to the battery 206 such that the battery 206, the solar panel 207, the PCB 209, and the filler 208 form a single layer having a relatively uniform thickness across the entire surface of the back plate 210. The PCB 209 can be positioned such that any light sources present on the PCB 209 will be aligned with the light guide 205 when the light guide 205 is positioned in the solar sign. The light guide 205 can be positioned on top of the first layer formed from the battery 206, the solar panel 207, the PCB 209, and the filler 208 in the solar sign. Light passing through the light guide 205 from an external light source can be passed to the surface of the solar panel 207. Further, the light guide 205 can be positioned in the solar sign such that a portion of the light guide 205 can receive light from a light source, such as a light source positioned on or electrically coupled to the PCB 209. In some implementations, the light source can be electrically coupled to but physically separate from the PCB 209 (e.g., on a separate circuit board module, etc.).

The inner diffusion film 204 can be positioned on top of the light guide 205, such that the light emitted from the light sources and extracted by the light extraction features on the surface of the light guide 205 is diffused through the inner diffusion film 204, thereby evenly illuminating the solar sign. The spacer 202 and the border 203 form another internal layer on top of the inner diffusion film 204. As shown, the spacer 202 can have a similar thickness to the border 203, and provide a buffer through which light from the top diffusion film 201 can pass before reaching the inner diffusion film 204. The final layer formed from the top diffusion film 201 can be positioned on top of the layer formed from the spacer 202 and the border 203. As described herein above, the top diffusion film 201 can include a printable surface exposed to the external environment. Inks such as latex inks, or other types of inks, can be printed directly onto the printable surface of the top diffusion film 201. In some implementations, the top diffusion film 201 can create weatherproof seal between the border 203 and the top diffusion film 201, thereby creating a weatherproof, printable sign. It should be understood that the various signs described herein can be scaled to any appropriate dimension, and the entire sign as pictured in FIGS. 7 and 8 can have a profile passable through a printer such that the printer can print on the top diffusion film 201.

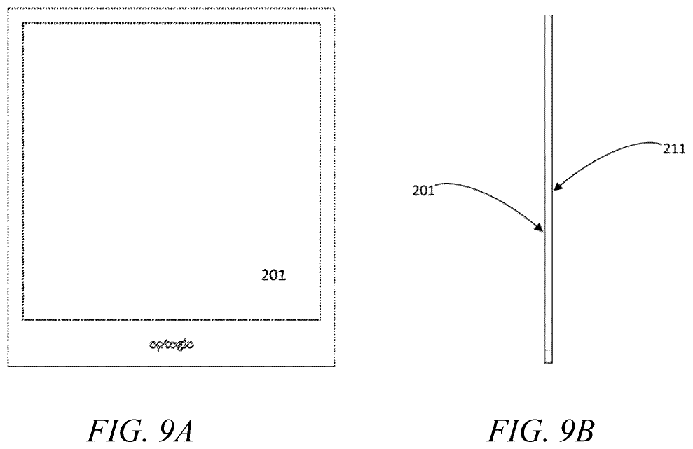

Referring briefly now to FIG. 9A, illustrated is a front view of the example printable solar sign sheet shown in FIGS. 7 and 8, in accordance with one or more implementations. As shown, when fully assembled, the solar sign can resemble a regular sign. Graphical designs can be printed directly onto the surface of the top diffusion film 201, and the area in the center portion (e.g., within the region defined by the opening in the border, etc.) can be illuminated in low-light conditions. The solar sign can be thin enough to be used directly as a print media. FIG. 9B illustrates a side view of the example printable solar sign, showing that the sign itself, when assembled, can be thin enough to be fed directly into a printer. Thus, the solar signs here can be used directly as an opto-electronic print media that is self-contained, weatherproof, and includes automatic control circuitry that controls sign illumination and charging. In some implementations, one or more brackets can be coupled to or form a part of the back plate 210, the rails 212, or the corner pieces 213. The brackets can allow the sign to be mounted to one or more frames, such as an A-frame, that allows the sign to be positioned at an angle that appears upright, but is at a slight angle to absorb optimal amounts of light from external light sources.

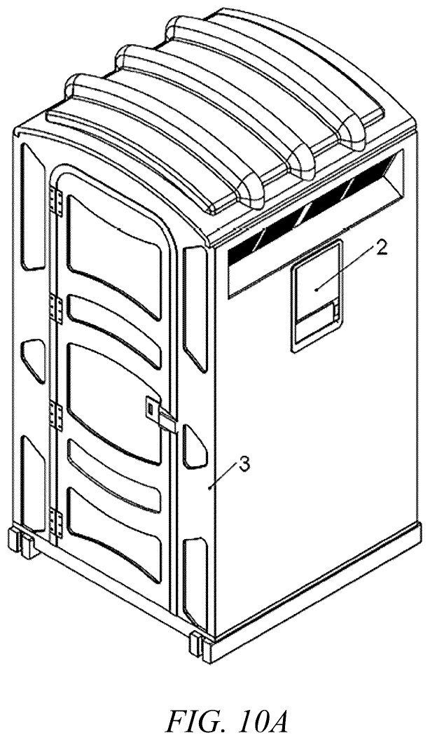

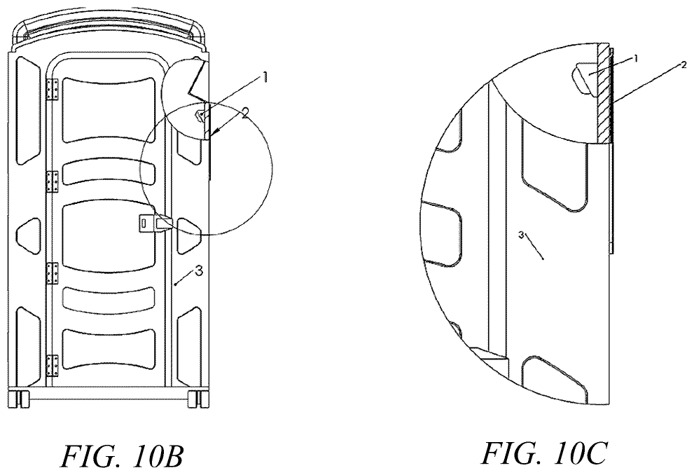

FIGS. 10A, 10B, and 10C illustrate diagrams of an example portable toilet system including an example dual-sided solar-powered sign, in accordance with one or more implementations. The dual-sided solar-powered signs described in connection with the following figures can include any of the features, structure, or implementation the functionality of, the solar signs described in connection with FIGS. 1-3 and 5-9.

As shown in FIG. 10A, a portable toilet system 3 is integrated with a solar-powered sign 2, which may be similar to, and include any of the structure and implement any of the functionality of, the solar-powered signs described herein. In this example, the solar-powered sign 2 is coupled to an external side of the portable toilet system 3. The solar-powered sign 2 can be coupled to or mounted on an exterior of any suitable structure using any type of mount, screws, adhesives, or other suitable coupling devices. The solar-powered sign 2 in this example is shown without an external diffusion film or overlay. However, it should be understood that a corresponding overlay or printed outer diffusion film may be included in the solar-powered sign 2 to display graphics, text, or other printed features as described herein.

The solar-powered sign 2, as described in detail above, may include one or more batteries, control electronics (e.g., a PCB), a solar panel that generates power that is stored in the one or more batteries, and one or more light guides that illuminate an outer surface of the solar-powered sign 2. In some implementations, the control electronics may provide power and control to an external light source.

FIGS. 10B and 10C show partial internal views of the portable toilet system 3 shown in FIG. 10A. As shown, an external light source 1 is positioned within the portable toilet system 3 and is at least electrically coupled to the control electronics of the solar-powered sign 2. In some implementations, the external light source 1 can be controlled according to one or more sensors, which may be positioned within the solar-powered sign. For example, motion sensors may be cause the external light source 1 to be activated, for example, in response to movement. In some implementations, ambient external brightness (e.g., determined based on sensors internal or external to the portable toilet, or within the solar-powered sign 2, may be utilized to activate or deactivate external light source 1. For example, when a brightness within or outside of the portable toilet system 3 falls below a threshold, the external light source 1 can be activated. In some implementations, combinations of sensor data may activate external light source 1 (e.g., both detected motion of an occupant and ambient brightness satisfying a threshold, etc.).

The external light source 1 may be any suitable light source, including an LED, OLED, an incandescent lamp, a fluorescent lamp, or another suitable light source. The solar-powered sign 2, or the portable toilet system 3, may include power circuitry (e.g., step-up, step-down, other power converters, etc.) to convert input power to a suitable voltage and current to drive the external light source 1. The external light source 1 can source power from the battery of the solar-powered sign 2. As such, the external light source 1 may be powered via solar energy captured by the solar panel of the external light source 1. In some implementations, the external light source 1 may be powered by an external power source (e.g., an external battery), which may also be charged using power generated via the internal solar panel of the solar-powered sign 2.

In some implementations, the solar-powered sign 2 may positioned with a recessed portion of the portable toilet system 3 (e.g., in a slot, etc.). As described in further detail here, an outer perimeter of the solar-powered sign 2 may include grooves or other features that create a friction-fit with one or more corresponding mechanical protrusions, tracks, or other external features on the exterior of the portable toilet system 3. In some implementations, the solar-powered sign 2 may include one or more connects that electrically couple to power input of the external light source 1 to provide, for example, power to illuminate the external light source 1. In some implementations, the control circuitry (e.g., the PCB, processor, etc.) of the solar-powered sign 2 may activate, deactivate, or otherwise control (e.g., adjust brightness) of the external light source 1. For example, the solar-powered sign may include or may be coupled to one or more ambient light sensors that detect brightness, and activate the external light source 1 as described herein based at least on the ambient brightness.

In some implementations, the control circuitry can receive power from one or more external power sources, such as an external DC power source, an external AC power source, an external battery, or another type of external power source. In some implementations, the external DC power source may include one or more external batteries. The control circuitry may utilize the power received via the external power source, for example, to charge the battery or to power one or more components of the solar-powered sign 2. The control circuitry may include power conversion components, such as DC-DC converters, AC-DC converters, or voltage regulators that generate and maintain proper voltage and current for the various components of the solar-powered sign 2.

In some implementations, the control circuitry may implement hybrid charging of the internal battery of the solar-powered sign 2, in which the control circuitry may charge the internal battery via one or more power sources (e.g., the internal solar panel, an external power source, etc.). In some implementations, hybrid charging may include charging the internal battery according to expected or received external light (e.g., utilizing external power to charge the battery when the internal solar panel is not generating suitable power, etc.). In some implementations, the control circuitry may implement hybrid charging for one or more external batteries that are electrically coupled to one or more components of the solar-powered sign 2. External power may be received via any suitable connector. Any of the solar-powered signs described herein may include connectors to receive power from one or more external sources, and may implement hybrid charging or hybrid powering (e.g., drawing power from both the internal battery and an external power source) to provide power to the internal battery or to other components of the solar-powered signs described herein.

Although a single external light source 1 is shown in FIGS. 10B and 10C, it should be understood that multiple external light source 1 may be provided within and may be electrically coupled to, and in some implementations controlled by the circuitry of, the solar-powered sign 2. One or more external light sources 1 may, in some implementations, be positioned on an exterior of the portable toilet system 3, such as above a door or of the portable toilet system 3. The portable toilet system 3 may be any type of portable toilet. In some implementations, the solar-powered sign 2 and the external light 1 may be utilized in arrangements other than coupled to a portable toilet system 3. For example, the solar-powered sign 2 and the external light 1 may be coupled to or configured in connection with portable tents, temporary structures, or any other structure (e.g., small buildings, sheds, outhouses) or location that may be illuminated via the external light 1. Further, the implementation shown in FIGS. 10B and 10C may, in some implementations, utilize a dual-sided solar sign, as described in connection with the following figures.

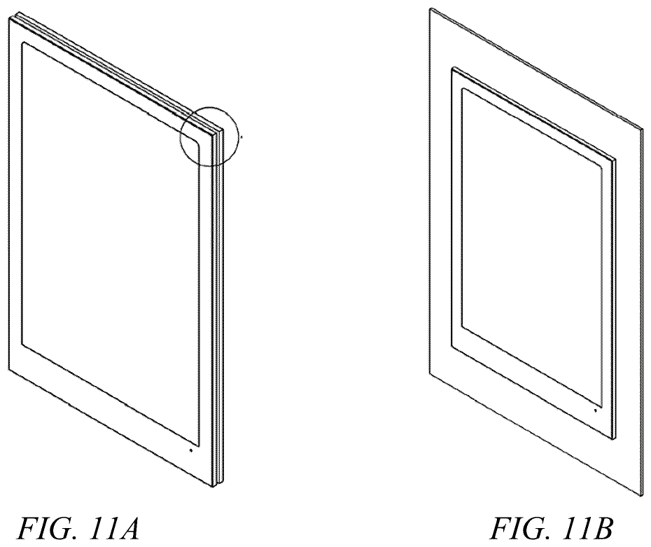

Referring to FIGS. 11A and 11B, illustrated are perspective views of an example dual-sided solar-powered sign, in accordance with one or more implementations. FIG. 11A shows an example dual-sided solar-powered sign with an outer diffusion film, which may include printed graphics, text, or other types of markings for signage. The dual-sided solar-powered sign shown in FIG. 11A includes two sides, each corresponding to a respective light guide and outer diffusion film. The dual-sided solar-powered sign shown in FIGS. 11A and 11B may be utilized in connection with the portable toilet system 3 shown in FIGS. 10A-10C.

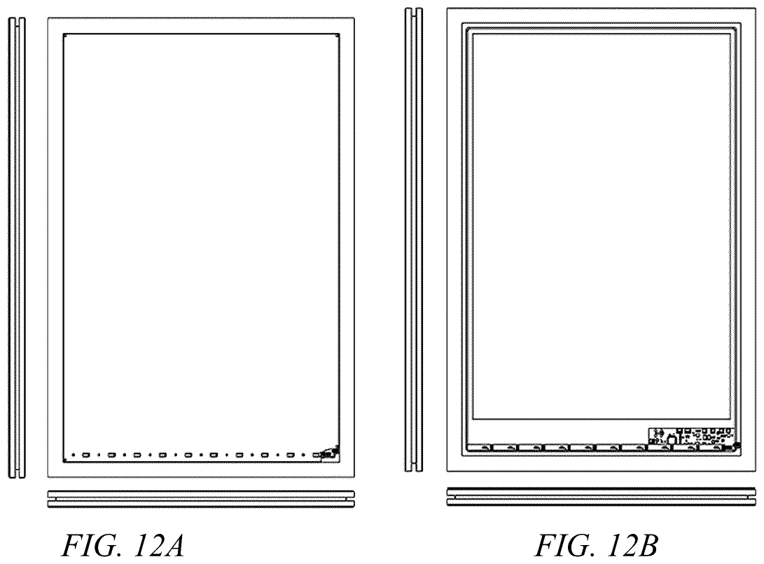

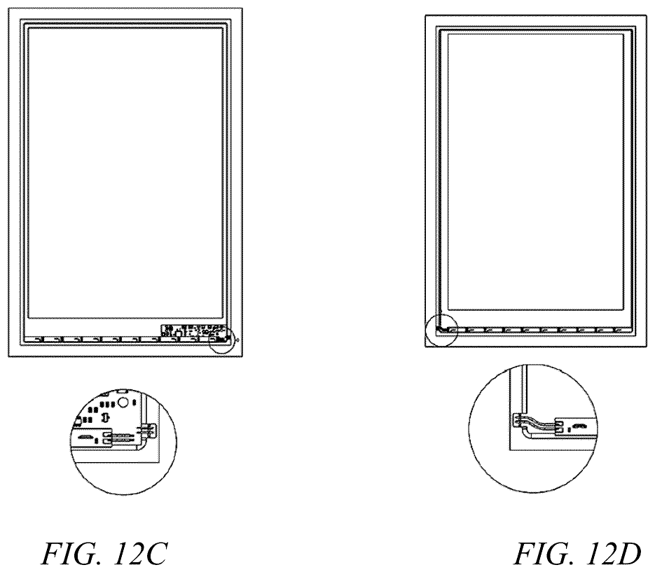

As shown in FIG. 12A, the dual-sided solar-powered sign includes a recessed ridge around its outer perimeter, which may mechanically couple with a mount or a structure upon which the dual-sided solar-powered sign is to be mounted. The ridge enables the dual-sided solar-powered sign to act as a barrier within a wall, surface, or other structure, similar to the arrangement shown in FIGS. 10A-10C. The dual-sided solar-powered sign shown in FIG. 12A may be mounted such that the dual-sided solar-powered sign can provide illumination to both the exterior and the interior of a structure. In some implementations, the dual-sided solar-powered sign may be mounted on a frame, such as an A-frame or post, which may be utilized to orient the dual-sided solar-powered sign in an environment.

As shown in FIG. 12B, the dual-sided solar-powered sign may be inserted into a mounting frame, which itself may form a part of a wall of a structure (e.g., portable toilet systems, small buildings, sheds, outhouses, etc.), or may be coupled to a structure, frame or mount, to orient the dual-sided solar-powered sign. As shown, the mounting frame can be inserted into the grooves defined along the perimeter of the dual-sided solar-powered sign. As shown, the mounting frame does not obscure either face of the dual-sided solar-powered sign, enabling efficient and complete illumination from the front and the back of the solar sign (e.g., which may provide external and internal light for a structure, etc.). The dual-sided solar-powered sign described may include any of the structure and functionality of the solar-powered signs described in connection with FIGS. 1-3 and 5-9.

As described in connection with FIGS. 10A-10C, the dual-sided solar-powered signs described in connection with FIGS. 11-13 may be activated or controlled by one or more sensors. For example, the internal light source(s) of the dual-sided solar-powered sign may be controlled according to input from an external sensor (e.g. a movement sensor), which may be integrated in the interior housing of the dual-sided solar-powered sign, or external and electronically coupled to the circuitry of the dual-sided solar-powered sign.

Control circuitry for motion sensing may, for example, trigger the illumination of the interior component for a fixed amount of time. The motion sensing may control one or more light sources of the dual-sided solar-powered sign (e.g., corresponding to one or more sides of the dual-sided solar-powered sign). In some implementations, the dual-sided solar-powered sign may be electrically coupled to an external light source, as described in connection with FIGS. 10A-10C, which may be controlled as described herein using power from the internal battery of the dual-sided solar-powered sign or from an external power source. In some implementations, the dual-sided solar-powered sign may be electrically coupled to control circuitry of the external light(s) (e.g., power converter or drive circuitry, etc.), and may activate, deactivate, or control the external light(s) as described herein.

Referring to FIGS. 12A, 12B, 12C, and 12D, illustrated are example diagrams of a post including a battery that can provide power to the solar-powered signs described herein. FIG. 12A shows a back view of the internal light guide and light sources within a housing of an example dual-sided solar-powered sign similar to that shown in FIGS. 11A and 11B. FIG. 12B shows a front view of the solar panel and light sources within the housing of an example dual-sided solar-powered shown in FIG. 12A. The dual-sided solar-powered sign shown in FIG. 12A includes two sides, each corresponding to a respective light guide and outer diffusion film. The dual-sided solar-powered sign shown in FIGS. 11A and 11B may be utilized in connection with the portable toilet system 3 shown in FIGS. 10A-10C.

The dual-sided solar-powered sign shown in FIGS. 12A and 12B can be similar in function and structure to the solar-powered signs described in connection with FIGS. 1-3 and 5-9. In this example, the PCB of the dual-sided solar-powered sign includes an additional connector to an additional set of lights sources, shown here as an additional strip of LEDs, that can shine light into a second light guide positioned on the back surface of the stack of layers of the dual-sided solar-powered sign. As shown, the light sources may fit within slots or openings in the second light guide. The second light guide may include light extraction features that illuminate the back surface of the solar-powered sign.

In FIG. 12B, a PCB is shown as connecting to a first set of light sources, which can be utilized to illuminate the primary light guide and the front surface of the dual-sided solar-powered sign. The dual-sided solar-powered sign can include a solar panel that is positioned beneath the light guide, as shown in FIG. 12B. The solar panel may be electrically coupled to the PCB, as described herein, and can provide power to charge an internal battery of the dual-sided solar-powered sign. The internal battery may supply power to both sets of light sources of the dual-sided solar-powered sign. Both sets of light sources may be controlled collectively or individually, for example, to illuminate one or more surfaces of the dual-sided solar-powered sign. In some implementations, one or more of the solar panel, the battery, or PCB/control circuitry may be external to the dual-sided solar-powered sign, and electrically coupled to one or more of the light sources of the dual-sided solar-powered sign.

FIGS. 12C and 12D show close-up views of the example connectors utilized to provide electric power to the light sources of the dual-sided solar-powered sign shown in FIGS. 12A and 12B. As shown in FIG. 12C, the front side of the dual-sided solar-powered sign shown in FIG. 12B may include a voltage and a ground connectors, and each of the first set of light sources of the dual-sided solar-powered sign may be powered in parallel. As shown in FIG. 12D, the back side of the dual-sided solar-powered sign shown in FIG. 12A includes similar connectors that bend around the back of the PCB to connect to the second set of light sources. In some implementations, the connectors may be defined on the back surface of the PCB, or may be included on a second PCB with circuitry dedicated to the components of the back side of the dual-sided solar-powered sign.

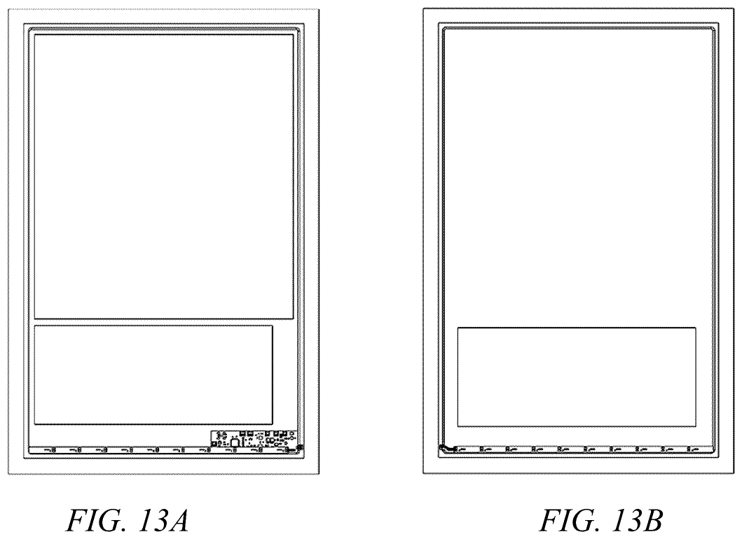

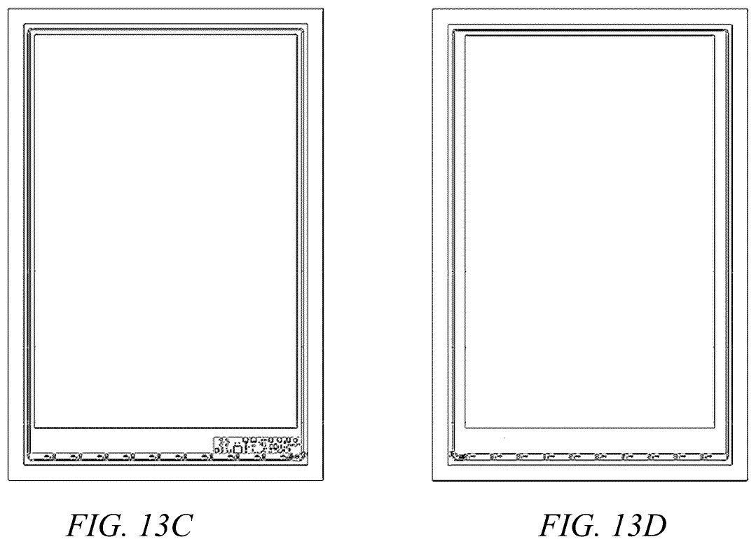

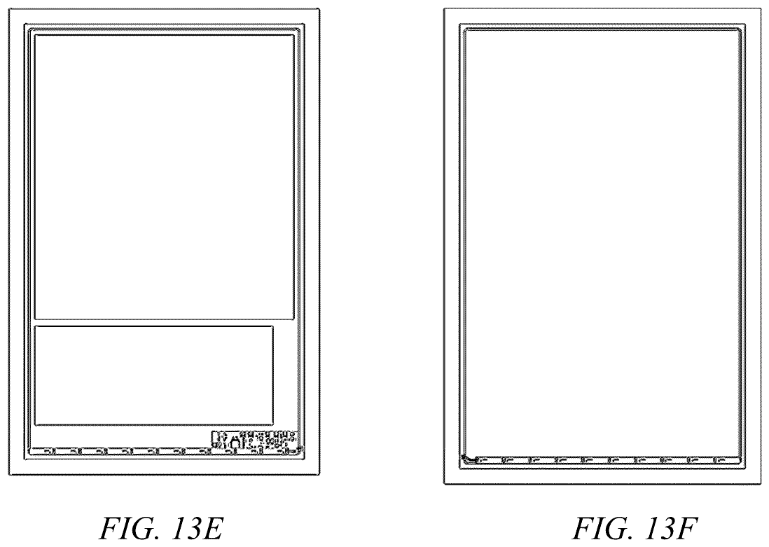

FIGS. 13A, 13B, 13C, 13D, 13E, and 13F illustrate example front and back diagrams of internal components of the dual-sided solar-powered signs described in connection with FIGS. 1-3 and 5-9, in accordance with one or more implementations. It should be understood that the components shown in FIGS. 13A-13F can may similar to the corresponding components of solar-powered signs described in connection with FIGS. 1-3 and 5-9. For example, the dual-sided solar-powered signs described in connection with FIGS. 13A-13F may include a solar-panel, an internal battery, a PCB or control circuitry, connectors that electrically coupled to internal light sources, and light guides that receive light emitted by the light sources, as described herein.

FIGS. 13A and 13B show an example implementation of a dual-sided solar-powered sign in which the battery is positioned beneath the internal solar panel of the dual-sided solar-powered sign, and is thick enough to be adjacent to a respective surface of each of the light guides on both sides of the dual-sided solar-powered sign. The internal battery may be positioned in one more slots defined in spacer layers or other layers of the dual-sided solar-powered sign, and may be electrically coupled to the PCB and the solar panel. FIG. 13A shows the front side of the dual-sided solar-powered sign, where the solar panel is exposed to a surface of the front light guide. FIG. 13B shows an opposite side of the internals of dual-sided solar-powered sign shown in FIG. 13A. As shown in FIGS. 13A and 13B, in this example, the internal battery is thick enough to be exposed to both the front and back sides of the dual-sided solar-powered sign, and is held in place in part by a spacer layer with an opening defined according to the dimensions of the internal battery.

FIGS. 13C and 13D show an example implementation of a dual-sided solar-powered sign in which the battery on a layer on the opposite side of the solar panel of the dual-sided solar-powered sign. The solar panel occupies a greater area in this example than the area shown in the example of FIG. 13A. The internal battery may be positioned in one more slots defined in spacer layers or other layers of the dual-sided solar-powered sign, and may be electrically coupled to the PCB and the solar panel, as described herein. FIG. 13C shows the front side of the dual-sided solar powered sign, where the solar panel is exposed to a surface of the front light guide, similar to the arrangement shown in FIG. 13A. FIG. 13D shows an opposite side of the internals of dual-sided solar-powered sign shown in FIG. 13C. As shown in FIG. 13D, in this example, the internal battery is thin, and exposed only at the side of the dual-sided solar-powered sign. The internal battery may be held in place in part by a spacer layer with an opening defined according to the dimensions of the internal battery.

FIGS. 13E and 13F show an example implementation of a dual-sided solar-powered sign in which the battery on a layer on the opposite side of the solar panel of the dual-sided solar-powered sign. In this example, as shown in FIG. 13E, the solar panel occupies an area similar to the area shown in the example of FIG. 13A, and the internal battery is be positioned below the solar pane of the dual-sided solar-powered sign. The internal battery, as described herein, may be electrically coupled to the PCB and the solar panel, and may be secured in place via one or more spacer layers. FIG. 13E shows the front side of the dual-sided solar powered sign, where the solar panel and the internal battery are exposed to a surface of the front light guide, similar to the arrangement shown in FIG. 13A. FIG. 13F shows an opposite side of the internals of dual-sided solar-powered sign shown in FIG. 13E. As shown in FIG. 13F, in this example, only a spacer layer is exposed to the back light guide, and neither the battery nor the solar panel are shown.

In the various implementations of single and dual-sided solar-powered signs described herein, internal components may be secured within a weatherproof and waterproof housing. The example solar-powered signs may each include at least two light guides and at least two layers of outer diffusion film or overlay layers, upon which graphics, text, or other signage content may be printed. The dual-sided solar-powered signs described herein may be electrically coupled to one or more external batteries, which may receive or provide power to the various components of the dual-sided solar-powered signs.

In some implementations, one or more light sources (or sets of light sources) may be controlled independently, including independent activation, deactivation, or brightness control, such that a first side of a dual-sided solar-powered sign may be activated at a different brightness than a second side of the dual-sided solar-powered sign. Various control components (e.g., processors of control circuitry, etc.) of the dual-sided solar-powered sign may control the light sources and sources of power (e.g., internal or external battery) utilized by the dual-sided solar-powered sign. In some implementations, a single light source or a single set of light sources may emit light into and illuminate multiple light guides simultaneously, such that a single set of light sources can emit light into both light guides, which in turn illuminate and emit light from both sides of a dual-sided solar-powered sign.

As used herein, the terms “about” and “substantially” will be understood by persons of ordinary skill in the art and will vary to some extent depending upon the context in which they are used. If there are uses of the term which are not clear to persons of ordinary skill in the art given the context in which it is used, “about” will mean up to plus or minus 10% of the particular term.

While the present disclosure has been described with reference to various implementations, it will be understood that these implementations are illustrative and that the scope of the present disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A system comprising:
a frame of a solar-powered sign supporting a solar sign sheet;
a solar panel disposed relative to the frame;
a light source configured to illuminate the solar sign sheet; and
a battery configured to store power generated via the solar panel and provide power to control circuitry configured to control the light source.

2. The system of claim 1, wherein the solar sign sheet comprises an outer diffusion film and an internal light guide.

3. The system of claim 1, wherein the solar panel being disposed relative to the frame includes the solar panel being located on an exterior of the frame.

4. The system of claim 1, wherein the light source is an external light source electrically coupled to the control circuitry and configured to receive power via the battery.

5. The system of claim 1, wherein the solar-powered sign is a dual-sided solar-powered sign, the system further comprising:
a second solar sign sheet disposed relative to the first solar sign sheet.

6. The system of claim 1, wherein the control circuitry is configured to:
monitor ambient light conditions by monitoring a voltage of the solar panel to determine if a threshold is met;
upon determining the threshold is met, turn on the light source;
determine whether a predetermined time period has elapsed; and
turn off the light source.

7. The system of claim 6, wherein the control circuitry is further configured to:
adjust a brightness of the light source over the predetermined time period.

8. A system comprising:
a first light guide configured to receive light from a first set of internal light sources to illuminate a first surface of a dual-sided solar-powered sign;
a second light guide configured to receive light from a second set of internal light sources to illuminate a second surface of the dual-sided solar-powered sign;
a solar panel configured to capture light; and
a battery configured to store power generated via the solar panel and provides the power to at least one of the first set of internal light sources or the second set of internal light sources.

9. The system of claim 8, wherein the solar panel is located on an exterior of a frame of the sign.

10. The system of claim 8, further comprising:
an external light source electrically coupled to the control circuitry and configured to receive power via the battery.

11. The system of claim 8, further comprising:
control circuitry configured to control the first set of internal light sources and the second set of internal light sources.

12. The system of claim 11, wherein the control circuitry is configured to:
monitor ambient light conditions by monitoring a voltage of the solar panel to determine if a threshold is met;
upon determining the threshold is met, turn on the internal light source;
determine whether a predetermined time period has elapsed; and
turn off the internal light source.

13. The system of claim 12, wherein the control circuitry is further configured to:
adjust a brightness of the internal light source over the predetermined time period.

14. A method for illuminating content, the method comprising:
collecting light using a solar panel of a solar-powered sign, wherein power generated via the solar panel is stored in a battery of the solar-powered sign;
monitoring ambient light conditions of an environment in which the solar-powered sign is location to determine if a threshold is met;
upon determining that the threshold is met, turning on an internal light source of the solar-powered sign;
determining whether a predetermined time period has elapsed; and
turning off the internal light source.

15. The method of claim 14, further comprising:
adjusting a brightness of the internal light source over the predetermined time period.

16. The method of claim 14, wherein monitoring ambient light conditions includes monitoring a voltage of the solar panel to determine ambient light conditions.

17. The method of claim 14, further comprising:
identifying an intermittent period of low ambient light; and
turning off the internal light source.

18. The method of claim 17, further comprising:
resetting the panel to a monitoring state.

19. The method of claim 14, wherein the solar powered sign is a dual-sided solar-powered solar sign.

20. The method of claim 14, wherein the solar panel is located on an exterior of a frame of the solar-powered sign.
